(19) United States
(12) Patent Application Publication
(10) Pub. No.: US 2013/0159416 A1
(43) Pub. Date: Jun. 20, 2013

(54) DOCUMENT MANAGEMENT SYSTEM AND DOCUMENT SERVER SYSTEM

(71) Applicant: Kazunori Hirabayashi, Kanagawa-ken (JP)

(72) Inventor: Kazunori Hirabayashi, Kanagawa-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/705,633

(22) Filed: Dec. 5, 2012

Related U.S. Application Data
(60) Provisional application No. 61/577,191, filed on Dec. 19, 2011.

(51) Int. Cl. H04L 29/06

(52) U.S. Cl. CPC H04L 65/403
USPC 709/204

(57) ABSTRACT

Conference information and a conference material related to the conference information are uploaded to a document distribution server from an information terminal in advance. A conference participant photographs, with a display terminal of the conference participant, a conference agenda created by the document distribution server on the basis of the uploaded conference information and conference material and transmits a photographed image to the document distribution server. Consequently, the conference material is automatically transmitted from the document distribution server to the display terminal of the conference participant. Therefore, it is possible to smoothly cope with an increase or a decrease in participants.

### CROSS-REFERENCE TO RELATED APPLICATIONS

This application is based upon and claims the benefit of priority from U.S. Provisional Application No. 61/577,191 filed on Dec. 19, 2011; the entire contents of which are incorporated herein by reference.

### FIELD

Embodiments described herein relate generally to a document management system and a document server system for promoting, using mobile terminals and the like, efficiency of distribution of a document necessary for a conference as electronic data and paper media and supporting operation of the conference and the like.

### BACKGROUND

Methods of distributing document data used in a conference and the like are devised. There is a system in which an organizer of a conference registers conference materials and conference participants in a server in advance and sets information necessary for the conference in advance while linking document data to user IDs (identifiers) of the participants and the participants access conference information using applications of dedicated terminals or general-purpose terminals.

However, if the conference participants increase or decrease, in the case of distribution of paper conference materials, additional labor and time for printing are required or excess prints are prepared. If electronic data is distributed, the system needs to be operated to change the conference information and send the data to additional participants again, leading to an increase in labor and time.

Therefore, there is a demand for a document management system and a document server system that can reduce labor and time for printing and excess prints and can cope with a change in conference participants and operate a conference smoothly.

### DESCRIPTION OF THE DRAWINGS

FIG. 1 is a schematic configuration diagram for explaining a first embodiment;

FIG. 2 is a flowchart for explaining a document distribution example;

FIG. 3 is a flowchart for explaining a function of steps S21 and S22 in FIG. 2;

FIG. 4 is a flowchart for explaining a function of steps S23 in FIG. 2;

FIG. 5 is a flowchart for explaining a function of steps S24 and S25 in FIG. 2;

FIG. 6 is a flowchart for explaining a function of steps S26 to S29 in FIG. 2;

FIG. 7 is a flowchart for explaining a function of step S30 in FIG. 2;

FIG. 8 is a flowchart for the function of step S30 in FIG. 2;

FIG. 9 is a diagram for explaining a conference agenda;

FIG. 10 is a diagram for explaining information concerning a link destination;

FIG. 11 is a diagram for explaining a display example of conference materials on a touch panel;

FIG. 12 is a schematic configuration diagram for explaining a document management system according to a second embodiment;

FIG. 13 is a flowchart for explaining a document distribution example in the second embodiment;

FIG. 14 is a schematic configuration diagram for explaining a document management system according to a third embodiment; and

FIG. 15 is a flowchart for explaining a function of steps S142 to S144 in FIG. 14.

### DETAILED DESCRIPTION

In general, according to one embodiment, there is provided a document management system in which an information terminal including at least a data input function and a display function, a document distribution server configured to manage conference information created by the information terminal and a conference material related to the conference information, and a display terminal including at least a photographing function and an operation function are connected by a network. The document distribution server creates a document of a conference overview in which link information to a storage location of the conference material is summarized and transfers the conference information to the display terminal that requests transfer of the conference material.

Embodiments are explained below with reference to the drawings.

### First Embodiment

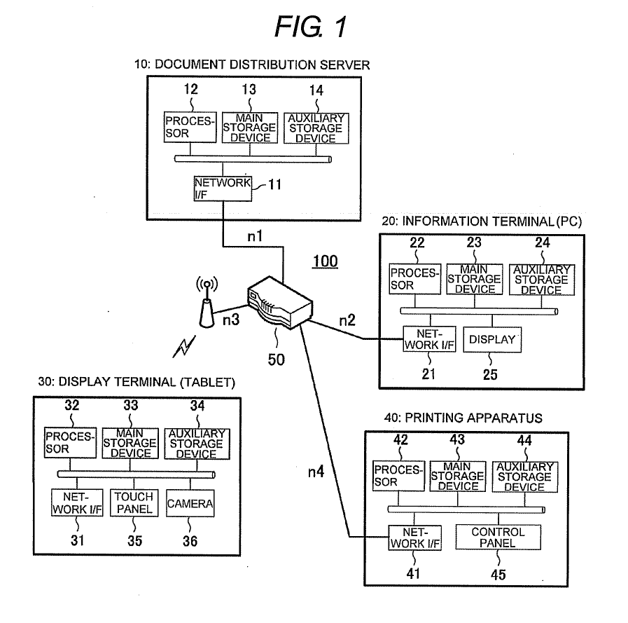

FIG. 1 is a schematic configuration diagram for explaining a first embodiment.

A document management system 100 includes a document distribution server 10, an information terminal 20, a display terminal 30, a printing apparatus 40, and a router 50 for connecting the document distribution server 10 and the printing apparatus 40.

The document distribution server 10 distributes a document and manages electronic conference data of conference information and conference materials related to the conference information. The document distribution server 10 includes a network interface 11, a processor 12, a main storage device 13, and an auxiliary storage device 14. The network interface 11 of the document distribution server 10 is connected to the router 50 via a network n1.

The information terminal 20 is, for example, a notebook PC (personal computer), a laptop PC, or a desktop PC. The information terminal 20 includes a function capable of performing setting of conference information, display of conference materials, and the like. The information terminal 20 includes a network interface 21, a processor 22, a main storage device 23, an auxiliary storage device 24, and a display 25. The network interface 21 of the information terminal 20 is connected to the router 50 via a network n2.

The display terminal 30 is, for example, a tablet PC. The display terminal 30 includes a function capable of performing setting of conference information, display of conference materials, and the like. The display terminal 30 includes a network interface 31, a processor 32, a main storage device 33, an auxiliary storage device 34, and a touch panel 35 including both display and operation functions. The network interface 31 of the display terminal 30 is connected to the router 50 via a network n3. Further, the display terminal 30 and the router 50 are connected by a wireless LAN.

The printing apparatus 40 enables printing of conference information, conference materials, and the like transmitted from the document distribution server 10. The printing apparatus 40 includes a network interface 41, a processor 42, a main storage device 43, an auxiliary storage device 44, and a control panel 45. The network interface 41 of the printing apparatus 40 is connected to the router 50 via a network n4.

An operation in the document distribution server 10 is executed as a computer program. The computer program stored in the auxiliary storage device 14 such as a HDD (Hard Disk Drive) is loaded to the main storage device 13 and operates on the processor 12.

An operation in the information terminal 20 is executed as a computer program. The information terminal 20 acquires an image from the auxiliary storage device 24 such as a flash memory. The display terminal 30 includes a camera 36 for photographing a printed matter or a screen of the information terminal 20 and capturing an image.

An operation in the printing apparatus 40 includes a function of receiving PDL (Page Description Language) data as printing information from the document distribution server 10 through the network n4 and printing the PDL data. An analysis and processing of information operate as a computer program. The computer program stored in a HDD or the like is loaded to the auxiliary storage device 44 and then executed in the processor 42. Printing is executed by a printing engine. Explanation of the printing is omitted.

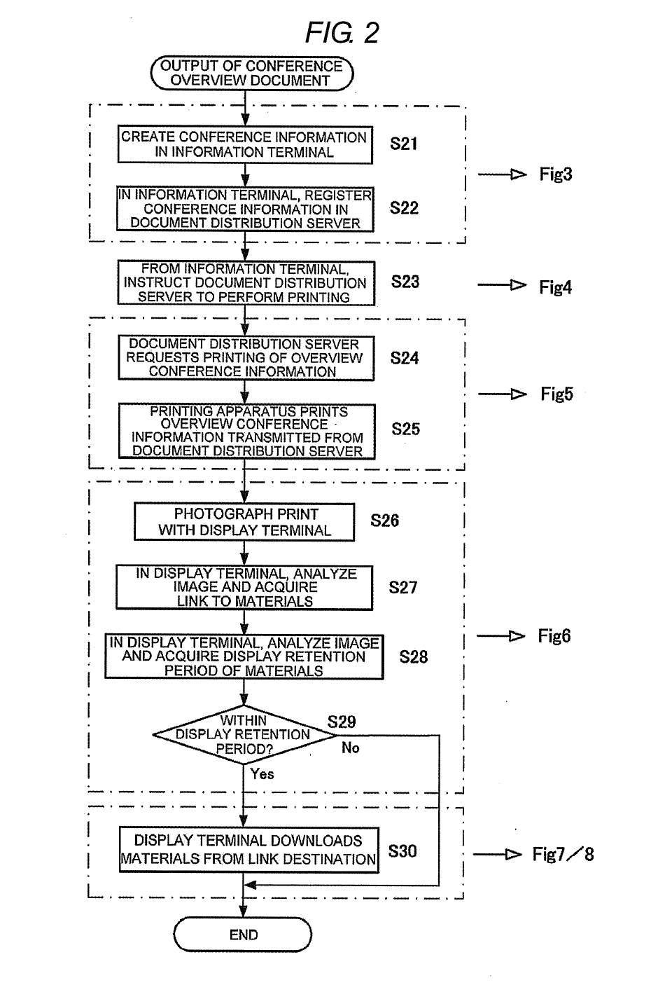

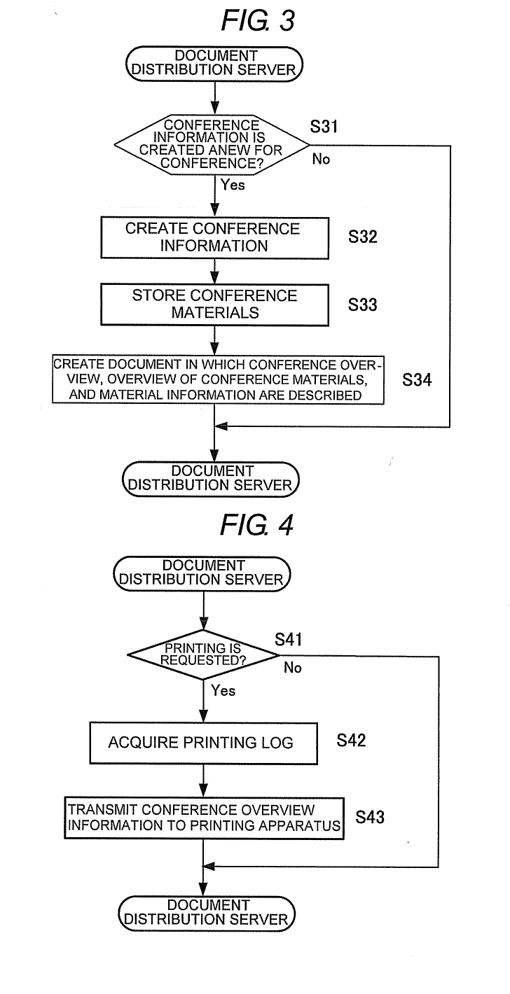

An example of basic document distribution is shown in a flowchart of FIG. 2. Flowcharts for explaining functions in FIG. 2 are shown in FIGS. 3 to 8. In the explanation of the flowcharts, the information terminal 20 is an information terminal of a conference organizer and the display terminal 30 is a display terminal of a conference participant.

First, the conference organizer creates conference information in the information terminal 20 (step S21). The conference organizer uploads the conference information to the document distribution server 10 that manages the conference information (step S22).

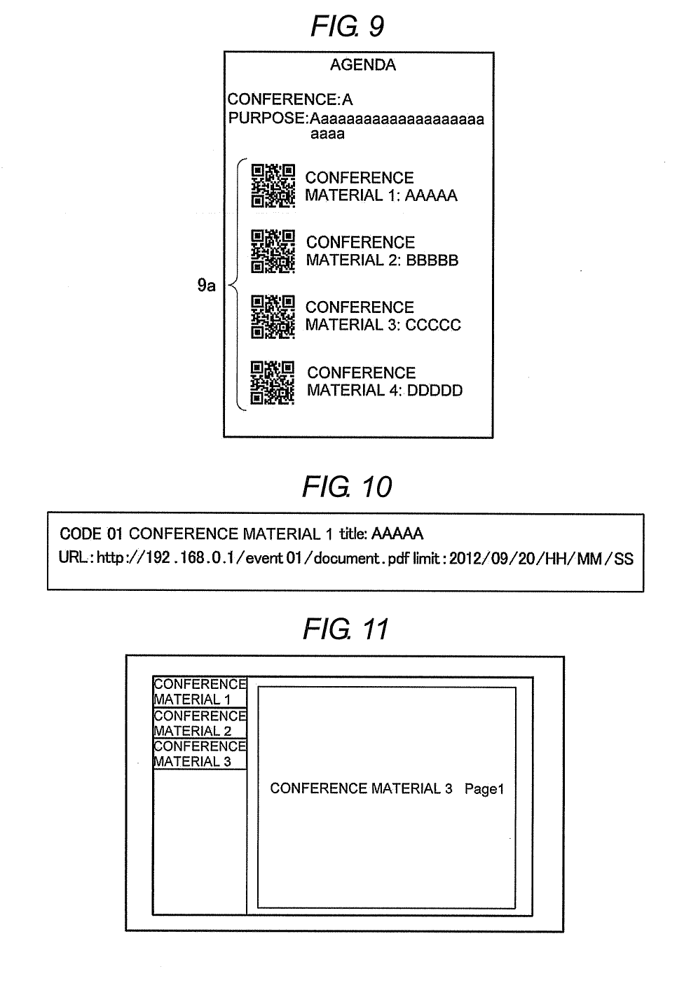

A conference overview document includes a conference agenda (printing and electronic data) and conference materials. In the conference agenda, as shown in FIG. 9, together with a title, a purpose, and the like of the conference, a two-dimensional barcode 9a embedded with a link to conference materials (a URL: an address of a web site) shown in FIG. 10, character information of the link, overviews and key points of the conference materials, information about a retention period of a document and a display period, and the like are described. When the conference organizer creates the conference information, the document distribution server 10 automatically creates the conference overview document. Created data is stored in the auxiliary storage device 14 of the document distribution server 10.

In FIG. 3, the document distribution server 10 determines whether conference information is created anew for a conference (step S31). If conference information is created anew, the document distribution server 10 creates the conference information (step S32) and stores created contents in the auxiliary storage device 14 (step S33). The document distribution server 10 creates, based on the contents stored in the auxiliary storage device 14, a document in which a conference overview, overviews of conference materials, the conference materials, and the like are described (step S34).

In FIG. 2, the conference organizer instructs, from the information terminal 20, the document distribution server 10 to perform printing (step S23).

In FIG. 4, the document distribution server 10 determines whether printing is requested (step S41). If printing is requested, the document distribution server 10 acquires a printing log (step S42) and transmits conference overview information to the printing apparatus 40 (step S43).

If, in step S23 in FIG. 2, the document distribution server 10 is instructed to perform printing, the document distribution server 10 requests the printing apparatus 40 to print the document overview (step S24). The printing apparatus 40 prints a conference overview document transmitted from the document distribution server 10 (step S25).

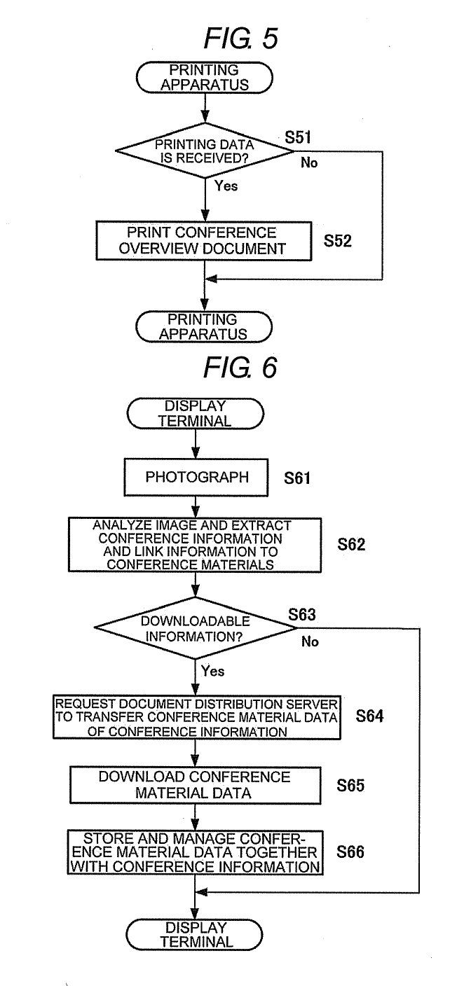

In FIG. 5, the printing apparatus 40 determines whether printing data is received from the document distribution server 10 (step S51). If printing data is received, the printing apparatus 40 receives the printing data transmitted from the document distribution server 10, generates a print of the conference overview document, and performs paper output (step S52). Upon receiving the printing data, the printing apparatus 40 may immediately execute printing or may execute printing after performing, before the printing, authentication of a non-contact ID card, a contact ID card, an input of a user password, or the like in order to improve security of the printing.

In step S26 in FIG. 2, the conference participant photographs, with the camera 36 of the display terminal 30, a conference agenda printed in step S52 or, for example, a conference agenda shown in FIG. 9 displayed on the display 25 of the information terminal 20. The conference participant analyzes a photographed image using an application of the display terminal 30 and accesses entities of conference materials necessary for the conference. The application retrieves and decodes the two-dimensional barcode 9a in the conference agenda.

The display terminal 30 acquires links to the conference materials from decoded information (step S27). The display terminal 30 extracts a display period of conference information and the conference materials from the decoded information (step S28). The display terminal 30 determines whether the display period of the conference information and the conference materials is within a display retention period (step S29). If the display period is within the display retention period, the display terminal 30 proceeds to step S30. Start time of the display retention period is time set in advance in the conference information of the document distribution server 10, time when a conference agenda document is created, or time when printing processing of document data is executed.

In FIG. 6, the conference participant photographs the print with the display terminal 30 (step S61), performs an analysis of a photographed image, and extracts the conference information and link information to the conference materials (step S62). The display terminal 30 determines whether the link information is downloadable information (step S63). If the link information is downloadable, the display terminal 30 requests the document distribution server 10 to transfer the conference materials of the conference information (step S64). The display terminal 30 downloads the conference materials transferred from the document distribution server 10 (step S65) and stores the conference materials in the auxiliary storage device 34 (step S66). The conference materials downloaded once are automatically deleted when the display retention period elapses.

In step S30 in FIG. 2, the display terminal 30 downloads the conference materials from link destinations.

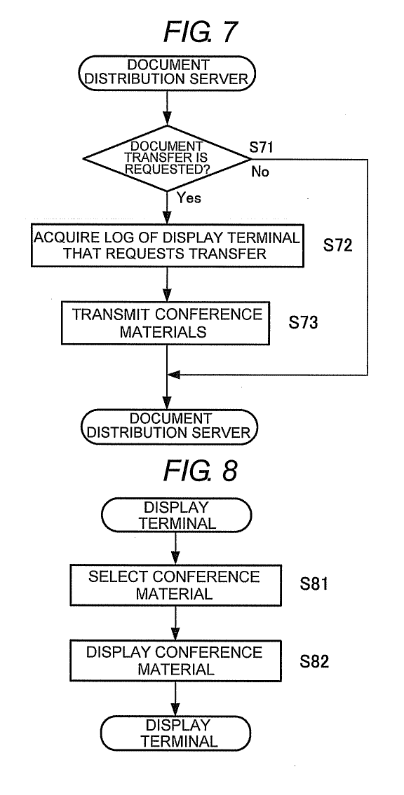

In FIG. 7, the document distribution server 10 determines whether transfer of the conference materials is requested (step S71). If transfer of the conference materials is requested, the document distribution server 10 acquires a log of the display terminal 30 that requests the transfer (step S72) and transmits the conference materials to the display terminal 30 (step S73).

In FIG. 8, the display terminal 30 displays the conference information transmitted from the document distribution server 10 on the touch panel 35, selects a displayed conference material (step S81), and displays contents of the conference material (step S82). The display terminal 30 displays the downloaded conference materials on the touch panel 35 as reference materials in the conference. FIG. 11 shows a display example of the conference materials displayed on the touch panel 35.

Beside the above, the document distribution server 10 stores and manages conference agenda document printing, a conference material transfer request from the display terminal 30, and a log of download in association with one another.

According to this embodiment, the conference information and the conference materials related to the conference information are uploaded from the information terminal to the document distribution server in advance and the conference participant simply photographs the printed conference information with the display terminal of the conference participant. Consequently, data is automatically transmitted from the document distribution server to the display terminal. The conference participant not only can print all the conference materials but also can simultaneously reduce printing costs because only the overviews of the conference materials can be printed. Further, the conference participants can cope with a problem of an information leak from the display terminal by, for example, checking the display retention period on the display terminal and deleting the conference materials if the display retention period expires.

### Second Embodiment

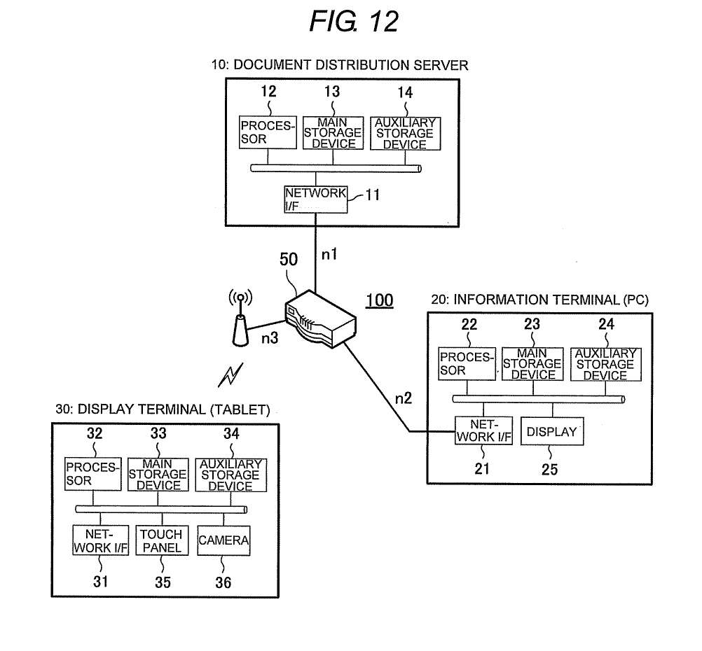

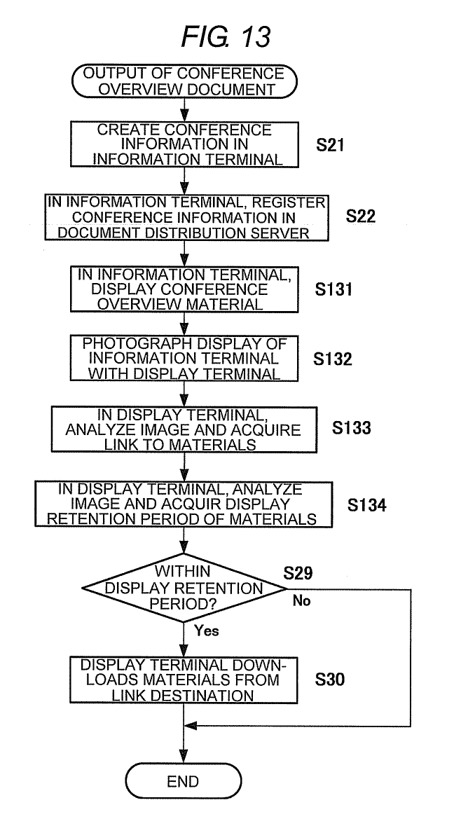

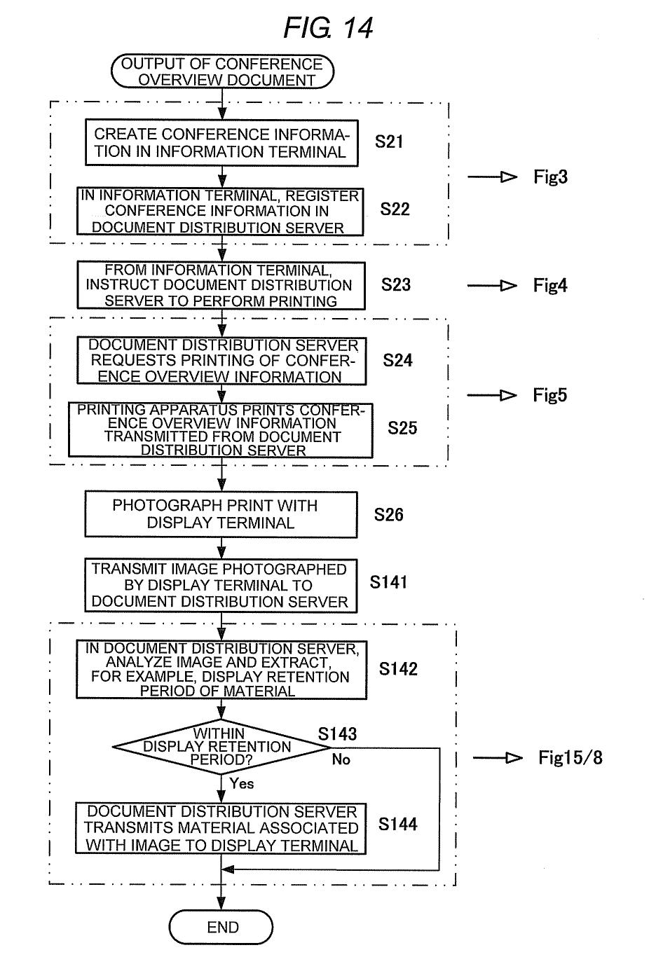

FIG. 12 shows a schematic configuration diagram of a second embodiment. In this embodiment, the configuration of a portion excluding the printing function from the document management system 100 is different from the configuration shown in FIG. 1. FIG. 13 is a flowchart for explaining a document distribution example in the second embodiment. Components having functions same as the functions shown in FIGS. 1 and 2 are denoted by the same reference numerals and signs.

In steps S21 and S22 in FIG. 13, processing explained below is performed. First, a conference participant creates conference information in the information terminal 20 and uploads the conference information to the document distribution server 10 that manages the conference information.

The information terminal 20 reads out a conference overview from the document distribution server 10 to which the conference information is uploaded in step S22 and displays the conference overview on the display 25 (step S131).

The conference participant photographs, with the camera 36 of the display terminal 30, the conference information displayed on the display 25 of the information terminal 20 (step S132).

The conference participant analyzes a photographed image using the application of the display terminal 30 and extracts link information to conference materials (step S133).

The conference participant analyzes the image using the application of the display terminal 30 and extracts a display retention period of the conference materials (step S134).

The display terminal 30 determines whether the conference materials are within the display retention period (step S29). If the conference materials are within the display retention period, the display terminal 30 downloads the conference materials from the link destinations (step S30).

The conference participant photographs, with the camera 36 of the display terminal 30, the conference information displayed on the display 25 of the information terminal 20. Acquisition of the conference information is not limited to this. A conference agenda created by the document distribution server 10 is distributed to a display medium in a document format such as a PDF (Portable Document Format). The conference participant photographs display data of the conference agenda with a camera attached to another display terminal equivalent to the display terminal and analyzes a photographed image using the application. Consequently, the conference participant can locally acquire the conference materials even if there is no print. In this case, it is possible to download the conference materials to the display terminal only by photographing and analyzing the distributed conference agenda.

In this embodiment, for example, in a conference with a small number of participants or when it is unnecessary to perform printing, it is possible to download conference materials to display terminals of conference participants without executing a change and printing of conference information of the document distribution server. Therefore, it is possible to smoothly prepare for a conference and proceed with the conference.

### Third Embodiment

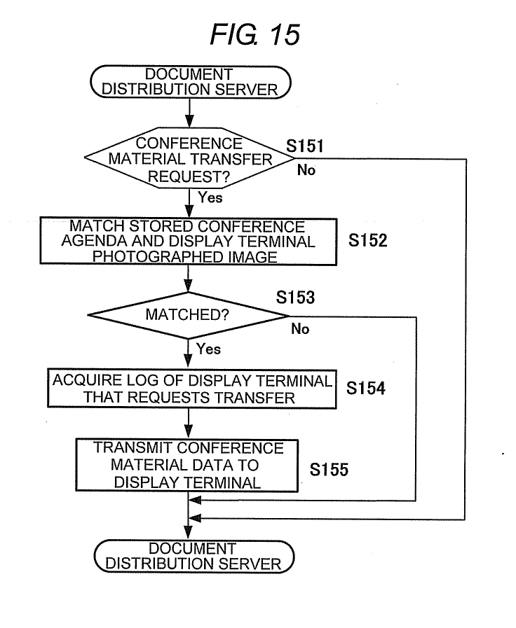

FIG. 14 is a flowchart for explaining a third embodiment. It is assumed that a hardware configuration is the same as the configuration shown in FIG. 1 except that a camera function is added to the information terminal 20. Among flowcharts for explaining functions in FIG. 14, for flowcharts same as the flowcharts in FIGS. 3 to 5 and 8 for explaining the functions in FIG. 2, FIGS. 3 to 5 and 8 are referred to. A flowchart for explaining a function in FIG. 14 other than these flowcharts is shown in FIG. 15.

The determination of the download of the conference materials in the first and second embodiments is performed in the application of the display terminal 30. In the third embodiment, authentication and determination of conference material download are performed by the document distribution server 10.

First, in steps S21 and S22 in FIG. 14, a conference organizer creates conference information in the information terminal 20 and uploads, together with a system ID of the information terminal 20, the conference information to the document distribution server 10 that manages the conference information. The information terminal 20 is described as an example of a terminal that creates conference information. However, the terminal may be the display terminal 30, a PC (Personal Computer) for conference information creation, or the like. In the following explanation, it is assumed that the information terminal 20 creates conference information and uploads the conference information to the document distribution server 10.

In steps S31 to S34 in FIG. 3, the document distribution server 10 determines whether conference information is created anew for a conference. If conference information is created anew, the document distribution server 10 creates the conference information and stores created contents in the auxiliary storage device 14. The document distribution server 10 creates, based on contents stored in the auxiliary storage device 14, a document in which information such as a conference overview, overviews of conference materials, and the conference materials is described.

In step S23 in FIG. 14, the conference organizer instructs, from the information terminal 20, the document distribution server 10 to perform printing.

In steps S41 to S43 in FIG. 4, if the request for printing is received from the information terminal 20, the document distribution server 10 authenticates the system ID of the information terminal 20. If it is determined that printing is requested and the system ID is authenticated, the document distribution server 10 acquires a printing log and transmits a conference overview document to the printing apparatus 40.

In steps S24 and S25 in FIG. 14, the document distribution server 10 requests the printing apparatus 40 to print the conference overview document. The printing apparatus 40 prints the conference overview document transmitted from the document distribution server 10.

In steps S51 and S52 in FIG. 5, the printing apparatus 40 determines whether printing data is received from the document distribution server 10. If printing data is received, the printing apparatus 40 receives the printing data transmitted from the document distribution server 10, generates a print of the conference overview document, and performs paper output. Upon receiving the printing data, the printing apparatus 40 may immediately execute printing or may execute printing after performing, before the printing, authentication of a non-contact ID card, a contact ID card, an input of a user password, or the like in order to improve security of the printing.

In step S26 in FIG. 14, the conference participant photographs, with the camera 36 of the display terminal 30, a conference agenda printed in step S52 or the conference agenda shown in FIG. 9 displayed on the display 25 of the information terminal 20.

The display terminal 30 transmits an image photographed by the camera 36 to the document distribution server 10 (step S141).

In FIG. 14, the document distribution server 10 that receives photographed image data from the display terminal 30 performs an analysis of the image, extracts a structure of a document and extracts a two-dimensional barcode embedded in the image and conference information such as a title of a conference (step S142). In step S142, the document distribution server 10 extracts a display retention period of the conference information and present date and time and determines whether the display retention period comes (step S143). If the display retention period expires, the document distribution server 10 automatically deletes the conference information.

If the conference information is within the display retention period, the document distribution server 10 transmits conference materials associated with the image, which is transmitted from the display terminal 30, to the display terminal 30 (step S144).

In FIG. 15, the document distribution server 10 determines whether transfer of the conference materials is requested (step S151). If transfer of the conference materials is requested, the document distribution server 10 matches an original version of the conference agenda document output by the document distribution server 10 according to the request of the information terminal 20 and an analysis result of the image data received from the display terminal 30 (step S152). As a result of the matching, the document distribution server 10 determines whether the image received from the display terminal 20 is a proper image (step S153). As means for the determination of the matching, it is possible to apply encoding to a two-dimensional barcode or the like and give a key of the two-dimensional barcode to the document distribution server 10 to determine whether the image is a proper image.

In steps S81 and S82 in FIG. 8, the display terminal 30 selects a conference material displayed on the touch panel 35, performs display of contents of the conference material, displays downloaded conference materials on the touch panel 35 as reference materials for the conference.

As explained above, the conference participant only has to perform work for photographing, with the camera of the display terminal of the conference participant, the printed conference agenda and transmitting a photographed image to the document distribution server together with the system ID of the display terminal. The document distribution server analyzes the system ID and the photographed image and determines propriety of download of the conference materials. Consequently, not only the information terminal of the conference organizer but also the display terminal of the conference participant does not need to include an application for performing, for example, the analysis of the photographed image.

In this embodiment, since the application for performing the analysis is provided on the document distribution server side, it is possible to simplify the application of the display terminal connected to the document distribution server. Since the analysis is performed in the document distribution server, it is possible to accurately carry out the analysis, management of authentication and devices, acquisition of a log, and the like.

As document distributing means, document distribution is determined via a physical device or a medium. Therefore, since wrong transmission or the like of a mail or the like less easily occurs, security is high.

The present invention is not limited to the embodiments explained above. For example, the printing apparatus 40 and a router 50A may also be connected by a wireless LAN. Similarly, the information terminal 20 and the router 50A may be connected by the wireless LAN and the document distribution server 10 and the router 50A may be connected by the wireless LAN. Further, the information terminal 20 and the display terminal 30 may have the same configuration as long as a camera is attached thereto. The document distribution server 10, the information terminal 20, and the like are connected via the router 50 on the network. However, the document distribution server 10, the information terminal 20, and the like may be connected via a hub.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

What is claimed is:

1. A document management system in which an information terminal including at least a data input function and a display function, a document distribution server configured to manage conference information created by the information terminal and a conference material related to the conference information, and a display terminal including at least a photographing function and an operation function are connected by a network, wherein
the document distribution server creates a document of a conference overview in which link information to a storage location of the conference material is summarized and transfers the conference information to the display terminal that requests transfer of the conference material.

2. The system according to claim 1, further comprising:
a printing apparatus including a function of printing the conference material according to a request from the document distribution server is connected to the document distribution server, wherein
the conference information printed by the printing apparatus is photographed by the display terminal, and
the document distribution server analyzes a photographed image and extracts the conference material.

3. The system according to claim 1, wherein the display terminal requests the document distribution server to transfer the extracted conference material.

4. The system according to claim 1, wherein
conference information, a conference material related to a conference, and a system ID are uploaded to the document distribution server in advance,
if a printing request for the conference material is received from the display terminal that uploads the conference information, the conference material related to the conference, and the system ID, the document distribution server prints a part of the conference information in the printing apparatus and, if an image obtained by photographing the print with a camera of the display terminal and contents registered in the document distribution server coincide with each other, transmits the conference material to the display terminal.

5. The system according to claim 1, wherein the conference overview document in which the conference information and information concerning a storage location of the conference material are summarized includes a two-dimensional barcode and a conference agenda.

6. A document server system in which an information terminal including at least a data input function and a display function and a display terminal including at least a photographing function and an operation function are connected by a network to a document distribution server configured to manage conference information created by the information terminal and a conference material related to the conference information, wherein
the document distribution server creates a document of a conference overview in which link information to a storage location of the conference material is summarized and transfers the conference information to the display terminal that requests transfer of the conference material.

7. The system according to claim 6, wherein the document distribution server is connected to the printing apparatus, creates a document of a conference overview in which the conference information and information concerning storage location of the conference document related to the conference information are summarized, and requests the printing apparatus to execute printing.

8. The system according to claim 6, wherein the document distribution server enables transmission of the conference material on the basis of the transfer request from the display terminal.

9. The system according to claim 6, wherein
conference information, a conference material related to a conference, and a system ID are uploaded to the document distribution server in advance,
if a printing request for the conference material is received from the display terminal that uploads the conference information, the conference material related to the conference, and the system ID, the document distribution server prints a part of the conference information in the printing apparatus and, if an image obtained by photographing the print with a camera of the display terminal and contents registered in the document distribution server are matched, transmits the conference material to the display terminal.

10. The system according to claim 6, wherein the conference overview document in which the conference information and the information concerning the storage location of the conference material are summarized includes a two-dimensional barcode and a conference agenda.
